(19) United States
(12) Patent Application Publication
(10) Pub. No.: US 2010/0214246 A1
(43) Pub. Date: Aug. 26, 2010

(54) APPARATUS AND METHOD FOR CONTROLLING OPERATIONS OF AN ELECTRONIC DEVICE

(75) Inventor: Young Sik PARK, Daegu (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/706,815

(22) Filed: Feb. 17, 2010

(30) Foreign Application Priority Data
Feb. 26, 2009 (KR) 10-2009-0016287

(51) Int. Cl. G06F 3/041

(52) U.S. Cl. 345/173

(57) ABSTRACT

An electronic device having a new touch interface to allow control of an operation of the electronic device is disclosed. In an input system of the electronic device, a touch screen and a touch pad include a first touch zone and a second touch zone, respectively, which are disposed adjacently and symmetrically to each other. The first touch zone receives continuous contact in association with the second touch zone, and creates first input information connected to second input information created by the second touch zone when the continuous contact, starting from the second touch zone, is inputted. Similarly, the second touch zone receives the continuous contact in association with the first touch zone, and creates the second input information connected to the first input information when the continuous contact, starting from the first touch zone, is inputted.

### CLAIM OF PRIORITY

This application claims, pursuant to 35 USC 119, priority to, and the benefit of the earlier filing date of, that patent application filed in the Korean Patent Office on Feb. 26, 2009, entitled “Apparatus and Method for Controlling Particular Operation of Electronic Device Using Different Touch Zones,”, and afforded serial number 10-2009-0016287, the contents of which are incorporated by reference herein.

### BACKGROUND OF THE INVENTION

1. Field of the Invention

The present invention relates to the field of a touch-based control technology and, more particularly, to a system for controlling an electronic device having together a touch screen.

2. Description of the Related Art

With communication technologies having been advanced dramatically, the advent of new techniques and functions in mobile devices has steadily aroused customers' interest. In addition, a variety of approaches to user-friendly interfaces have been introduced in the art.

Particularly, many mobile devices today have employed a touch screen instead of, or in addition to a typical keypad. Furthermore, some mobile devices have adopted a touch pad to replace a normal dome key.

Such touch-based input members may offer a user an easier and more intuitive input interface. However, a mobile device which has only one of a touch screen and a touch pad may be relatively ineffective in controlling its operation through an input interface.

Therefore, a mobile device having both a touch screen and a touch pad has been developed to enhance its control efficiency. This conventional mobile device may, however, have an unfavorable drawback that a touch screen and a touch pad are separately and individually used. When a input event happens continuously on both a touch screen and a touch pad, this conventional mobile device may regard a continuous input event as discrete input instructions. That is, although having two types of input members, such a conventional mobile device may fail to support a control function based on continuous contacts.

### BRIEF SUMMARY OF THE INVENTION

An aspect of the present invention is to provide a technique for controlling a particular operation of an electronic device (including a mobile device and a display device) by accepting, as a single gestural input, continuous inputs on different touch zones of such a device.

Another aspect of the present invention is to provide a technique for controlling a particular operation of an electronic device by admitting continuous inputs, which occur on both a touch screen and a touch pad of the electronic device, to be a single gestural input.

Still another aspect of the present invention is to provide a technique for controlling a particular operation of an electronic device by activating at least one of a touch screen and a touch pad, which are disposed adjacently.

Yet another aspect of the present invention is to provide a technique for processing a user interface of an electronic device according to interactions on both a touch screen and a touch pad which are contiguously arranged.

Further another aspect of the present invention is to provide a technique for controlling a particular operation of an electronic device, which has an organized combination of different regions such as a graphical user interface (UI) region and a physical UI region, by regarding continuous contacts on such different regions as a single sequence of inputs.

According to one aspect of the present invention, an input system of an electronic device having different touch zones comprising: a touch screen including a first touch zone disposed adjacently and symmetrically to a second touch zone, the first touch zone being configured to receive a continuous contact in association with the second touch zone, and the first touch zone creating first input information connected to second input information created by the second touch zone when the continuous contact starting from the second touch zone is inputted; and a touch pad including the second touch zone configured to receive the continuous contact in association with the first touch zone, the second touch zone creating the second input information connected to the first input information created by the first touch zone when the continuous contact starting from the first touch zone is inputted.

According to another aspect of the present invention, provided is an electronic device comprising: a touch screen including a first touch zone; a touch pad disposed near the touch screen and including a second touch zone disposed adjacently to the first touch zone; and a control unit configured to determine an input mode depending on an executed application, and to control a specific function in response to input information received from the first and second touch zones in the determined input mode.

According to still another aspect of the present invention, provided is a method for controlling an operation of an electronic device having different touch zones, the method comprising: determining a type of an input event received from the different touch zones; if the input event is caused by a continuous contact, determining an input mode using the different touch zones; if the input mode is a wheel mode, detecting angular information corresponding to the input event; and controlling a specific function of the operation in response to the input event by using the angular information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a view which illustrates examples of an electronic device having different touch zones in accordance with an exemplary embodiment of the present invention.

FIG. 2 is a view which illustrates types of a touch input on different touch zones of an electronic device in accordance with an exemplary embodiment of the present invention.

FIGS. 3A and 3B are flow diagrams which illustrate a method for controlling a particular operation of an electronic device having different touch zones in accordance with an exemplary embodiment of the present invention.

FIG. 4 is a flow diagram which illustrates a process of dealing with a user's input event in accordance with an exemplary embodiment of the present invention.

FIG. 5 is a screen view which illustrates an example of executing a predefined function assigned to tap points on different touch zones in accordance with an exemplary embodiment of the present invention.

FIGS. 6 to 8 are screen views which illustrate examples of executing a predefined function through a sweep event on different touch zones in accordance with an exemplary embodiment of the present invention.

FIG. 9 is a screen view which illustrates an example of executing a predefined function depending on a tap event and a sweep event on different touch zones in accordance with an exemplary embodiment of the present invention.

FIG. 10 is a block diagram which illustrates a configuration of an electronic device in accordance with an exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

The present invention relates to a method, an apparatus and an input system for a control of operations in an electronic device. Embodiments of this invention may utilize a touch screen as a display unit of the electronic device. Specifically, some embodiments may use a full touch screen wherein the entire area of the display unit is formed as a touch screen, and others may use a half touch screen wherein a partial area of the display unit is formed as a touch screen.

In embodiments of this invention, two touch zones of different types (hereinafter, will be referred to as different touch zones) include a first touch zone defined in a touch screen, for example, and a second touch zone defined in a touch pad, for example, both of which are disposed adjacently. That is, embodiments of this invention may propose a new touch interface for a user's input through an organized combination between a touch screen and a touch pad.

A new touch interface in embodiments of the present invention may be composed of a graphical user interface (GUI) region having a first touch zone and a physical user interface (PUI) region having a second touch region. In this disclosure, PUI refers generally to a physical or mechanical medium of interactions between human and an electronic device. A button, a switch, a grip, a lever, a rotator, a wheel, etc. are known as examples of PUI. Furthermore, GUI refers generally to a pictorial representation which permits a user to interact with an electronic device.

In embodiments of this invention described herein, a touch screen and a touch pad will be used as representative examples of a GUI region and a PUI region, respectively. However, this is exemplary only and not to be considered as a limitation of the present invention. As will be understood by those skilled in the art, various forms of GUI and PUI may be alternatively used for this invention.

In embodiments of this invention, the first touch zone in the GUI region and the second touch zone in the PUI region may be disposed adjacently and symmetrically. In particular, when continuous contacts occur on the first and second touch zones, these contacts are accepted as a single gestural input for controlling a particular operation of an electronic device.

In embodiments of this invention, a combination of the first and second touch zones disposed adjacently may assume the form of a wheel, where one half is physically formed by the first touch zone corresponding to a touch screen and the other half is graphically formed by the second touch zone corresponding to a touch pad. The first touch zone in the touch screen may temporarily output virtual items adapted to respective specific applications executed in an electronic device.

An input system of an electronic device according to embodiments of this invention comprises a touch screen and a touch pad. The touch screen includes a first touch zone disposed adjacently and symmetrically to a second touch zone. Also, the first touch zone is configured to receive continuous contacts in association with the second touch zone, and creates first input information connected to second input information created by the second touch zone when the continuous contacts starting from the second touch zone is inputted. The touch pad includes the second touch zone configured to receive the continuous contacts in association with the first touch zone. Also, the second touch zone creates the second input information connected to the first input information created by the first touch zone when the continuous contacts starting from the first touch zone is inputted.

In some embodiment of this invention, the input information may include angle information corresponding to the continuous contacts through the first touch zone and the second touch zone. The touch screen may have an entire touch zone or a partial touch zone adjacent to the touch pad, the partial touch zone including a half touch zone. Particularly, the first touch zone may be formed of the half touch zone which offers coordinate information or angular information corresponding to a user's input event. Additionally, the half touch zone may be configured to display a virtual item corresponding to an executed application. The scroll control zone may be configured to offer coordinate information in connection with a single contact or offer angular information in connection with the continuous contacts according to an input mode depending on an executed application of the electronic device.

An electronic device according to embodiments of this invention comprises a touch screen including a first touch zone; a touch pad disposed near the touch screen and including a second touch zone disposed adjacently to the first touch zone; and a control unit configured to determine an input mode depending on an executed application, and to control a specific function in response to input information received from the first and second touch zones in the determined input mode.

In one aspect of this invention, the input mode may include a touch mode that allows a single input from the first and second touch zones, and a wheel mode which allows continuous inputs from the first and second touch zones. In the touch mode, the control unit may be further configured to detect coordinate information offered from the first and second touch zones, and to control the specific function by using the coordinate information. In the wheel mode, the control unit may be further configured to detect angular information offered from the first and second touch zones, and to control a specific function by using the angular information. Particularly, if the angular information is sequentially offered from the first and second touch zones, the control unit may be further configured to accept the angular information as a single gestural input. Meanwhile, the angle information may be assigned in advance to the scroll control zone by using a predefined range of values corresponding to a surface size of the scroll control zone.

According to embodiments of this invention, an electronic device determines a type of an input event received from the different touch zones; if the input event is caused by continuous contacts, determines an input mode using the different touch zones; if the input mode is a wheel mode, detects angular information corresponding to the input event; and controls a specific function in response to the input event by using the angular information.

In one aspect of the invention, the different touch zones may form a scroll control zone which includes a first touch zone of a touch screen and a second touch zone of a touch pad, the first and second touch zones having an organized combination and a symmetric structure. If the input event is caused by a single contact, the electronic device may detect coordinate information corresponding to the input event; and control a specific function in response to the input event by using the coordinate information. If the angular information is offered from one of the first and second touch zones, the electronic device may detect the angular information in one of the first and second touch zones. If the angular information is sequentially offered from both the first and second touch zones, the electronic device may detect the angular information in both the first and second touch zones while accepting the angular information as a single gestural input.

As discussed above, an electronic device according to this invention allows a control using different touch zones of the first touch zone and second touch zone. Embodiments of this invention to be described hereinafter will use a mobile device, also referred to as a portable device, a handheld device, etc., as a representative example of an electronic device. However, this is exemplary only and not to be considered as a limitation of the present invention. Many types of electronic devices which have an input unit for receiving a user's touch-based gestural input and a display unit for offering an output in a visual manner may also be favorably applied to this invention.

For instance, a great variety of well known or widely used mobile devices such as mobile communication terminals, a personal digital assistant (PDA), a portable game console, a smart phone, a digital broadcasting player, a smart phone, etc. may be contained in the electronic device of this invention. Additionally, display devices or players such as TV, LFD (Large Format Display), DS (Digital Signage), media pole, etc. may be regarded as the electronic device of this invention. That is, the electronic device may include all information and communication devices, multimedia devices, and their varied or derivative devices. Meanwhile, input units used for this invention may include, but not limited to, a touch screen, a touch pad, a motion sensor, a voice recognition sensor, a remote controller, a pointing device, and any other equivalents.

Although embodiments of this invention may use a configuration of a mobile device in order to describe hereinafter a method, an apparatus and an input system of this invention, it will be understood by those skilled in the art that the following configuration is not limited to mobile devices and may be favorably applied to any other types of electronic devices.

Now, a mobile device having different touch zones in accordance with some embodiments of this invention will be described hereinafter. It will be understood by those skilled in the art that the present invention is not limited to the following embodiments.

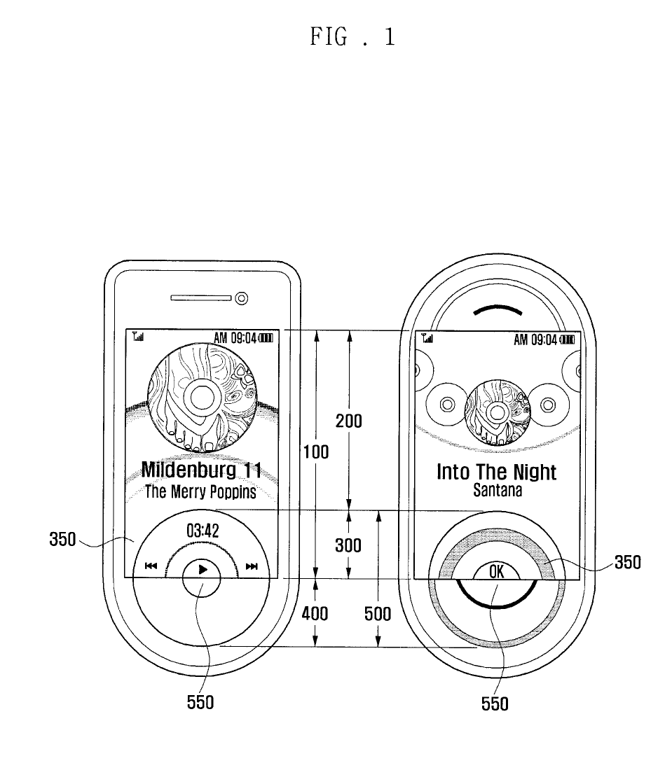

FIG. 1 is a view which illustrates examples of an electronic device having different touch zones in accordance with an exemplary embodiment of the present invention.

Referring to FIG. 1, the mobile device has a display unit and an input unit. In this embodiment, the display unit is a touch screen 100, especially a full touch screen, and the input unit is a touch pad 400. That is, the mobile device in this embodiment includes the touch screen 100 and the touch pad 400, which are disposed adjacently. In FIG. 1, the touch pad 400 is disposed near the lower side of the touch screen 100.

Described herein is a case where the display unit is formed as a full touch screen. However, the mobile device of this invention is not limited to the use of a full touch screen. The display unit may be formed of various well known or widely used display devices such as a liquid crystal display (LCD), a plasma display panel (PDP), an organic light emitting diodes (OLED), and so forth. Additionally, the display unit may be formed as a half touch screen or any other equivalent in the proximity of the touch pad 400.

The touch screen 100 may be classified into a display zone 200 and a half touch zone 300. This classification is, however, to facilitate the explanation only.

Actually, the display zone 200 not only outputs information on a screen, but also receives a user's touch input if the touch screen 100 is a full touch screen. Similarly, the touch zone 300 not only receives a user's touch input, but also outputs information on a screen. In particular, the half touch zone 300 may offer at least one virtual item 350 in the form of GUI that varies to be adapted to a specific application executed in the mobile device.

The virtual item 350 may be displayed while varied according to different types of executed applications, and also may have various forms such as icon, text, image, line, etc. suitable for offering various functions of applications. The location and shape of the virtual item 350 are not fixed to specific locations and are changeably provided depending on the type of executed application in the half touch zone 300. Related examples will be described.

The touch pad 400 is a kind of physical medium that allows processing a user's input (herein, also referred to as an input event) through touch-based interaction between a user and the mobile device. In particular, the half touch zone 300 of the touch screen 100 and a touch zone of the touch pad 400 together form an organized combination structure.

The mobile device according to embodiments of this invention may have a new input interface formed by the organized combination structure between the half touch zone 300 of the touch screen 100 and a touch zone of the touch pad 400. This new input interface will also be referred to as a scroll control zone 500.

That is, the scroll control zone 500 may be composed of the half touch zone 300, a part of a GUI region, and another touch zone of the touch pad 400, a part of a PUI region. These two touch zones are disposed adjacently and offered in the organized combination structure. In FIG. 1, the touch zone of the touch pad 400 is disposed near the lower side of the half touch zone 300.

According to some embodiment, two input modes, namely, a touch mode and a wheel mode are provided depending on input events on the scroll control zone 500. The touch mode refers to a mode that allows controlling the operation of the mobile device through a tap event on one of the half touch zone 300 and the touch zone of the touch pad 400 in the scroll control zone 500. The wheel mode refers to a mode that allows controlling the operation of the mobile device through a sweep event on at least one of the half touch zone 300 and the touch zone of the touch pad 400 in the scroll control zone 500. Particularly, in the wheel mode, an input event which is continuously made between the half touch zone 300 and the touch zone of the touch pad 400 is accepted as a single gestural input.

In one embodiment, if a single, continuous input event happens in the scroll control zone 500, coordinate information about a user's input event is obtained in both the half touch zone 300 and the touch zone of the touch pad 400, respectively. Also, if a single, continuous input event happens in the scroll control zone 500, angular information about a user's input event is obtained in both the half touch zone 300 and the touch zone of the touch pad 400, respectively.

For instance, when a tap event occurs on the half touch zone 300 or the touch zone of the touch pad 400, values of x and y coordinates may be obtained through a coordinate register. On the other hand, when a sweep event occurs in the half touch zone 300, angular values within a predefined range (e.g., from 0 to 255) may be obtained through a scroll position register. Such angular values may be allotted in a clockwise direction to the scroll control zone 500. In a case of a sweep event made by a move after a touch, a speed scroll gesture function may be offered by detecting an input speed until the touch is released.

In another embodiment of this invention, coordinate information about a sweep event may be obtained in the half touch zone 300, whereas angular information about a sweep event may be obtained in the touch zone of the touch pad 400. In this case, if angular information begins to be obtained in the touch zone of the touch pad 400 while coordinate information is being obtained in the half touch zone 300, such an input event may be regarded as a single, continuous input.

Meanwhile, the scroll control zone 300 includes a result request zone 550. Specifically, the result request zone 550 refers to a zone to which a confirmation function and a selection function are allotted and which allows a request for the result of executing a particular operation. The result request zone 550 may have a symmetric form on both the half touch zone 300 and the touch zone of the touch pad 400, as shown in FIG. 1.

The configuration and shape of the mobile device shown in FIG. 1 are exemplary only and not to be considered as a limitation of the present invention. If the mobile device has an interactive, adjoining, organized combination structure of different touch zones, any other configurations and shapes will be favorably applied to this invention.

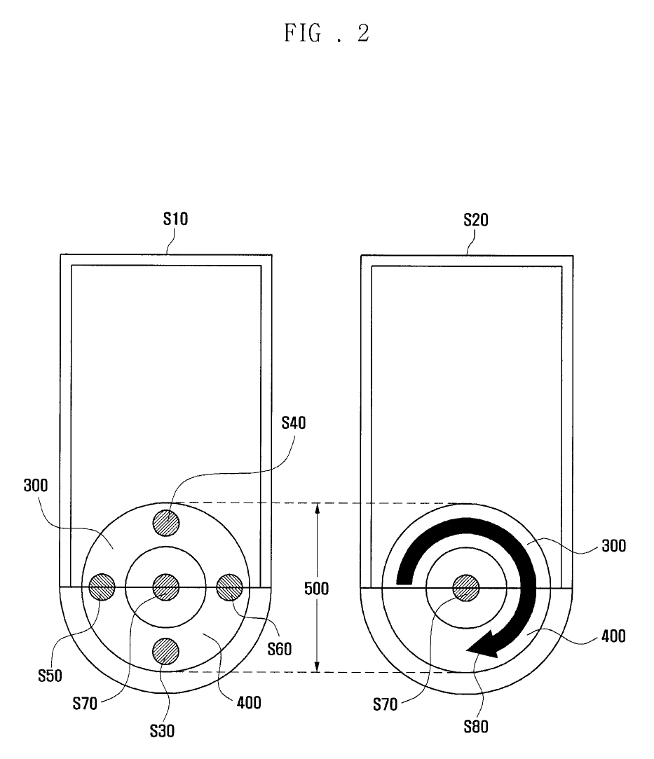

FIG. 2 is a view which illustrates types of a touch input on different touch zones of a mobile device in accordance with an exemplary embodiment of the present invention.

Referring to FIGS. 1 and 2, the mobile device according to aspects of this invention may have the touch screen 100 and the touch pad 400 adjacently disposed. A user's input event may occur on different touch zones, namely, the half touch zone 300 (herein, also referred to as a first touch zone) of the touch screen 100 and the touch zone (herein, also referred to as a second touch zone) of the touch pad 400.

In embodiments of this invention, a user's input event may include, but not limited to, a tap event and a sweep event. If necessary, the display zone 200 of the touch screen 100 may also receive a user's input event. Such a user's input event may further include, or may also be referred to, as a touch event, a flick event, a drag and drop event, a move event, etc. Embodiments of this invention may use an organized interaction of a tap event and a sweep event through the first and second touch zones.

A reference number S10 indicates a case where a tap event happens. In order to detect such a tap event, a plurality of tap points S30, S40, S50, S60 and S70 may be allotted to the first and second touch zones 300 and 400. Such tap points S30 to S70 may be defined differently and disposed in every executable application. In each executable application, the respective tap points S30 to S70 may have their own functions individually assigned thereto.

A reference number S20 indicates another case where a sweep event happens. In order to detect such a sweep event, the first and second touch zones 300 and 400 may form together a circular structure. A sweep event may be made in a clockwise direction, as indicated by a reference number S80, or a counterclockwise direction.

Various examples of controlling a particular operation of the mobile device through a tap event and a sweep event will be described later.

In the meantime, the first touch zone 300 may be displayed in a predetermined shape which is symmetrical with that of the second touch zone 400. The shape of each touch zone may be a semicircle, for example. That is, this invention can utilize different touch zones with a symmetric structure as a new input interface, namely, the aforesaid scroll control zone 500.

The scroll control zone 500 may have an adjoining, organized combination structure of the first and touch zones 300 and 400, respectively, in order to allow continuous contacts such as a sweep event based on a user's gesture. Continuous contacts occurring on the scroll control zone 500 may be admitted to be a single gestural input, and thereby a particular operation of the mobile device assigned to a sweep event may be processed.

Specifically, a single gestural input may be regarded as particular instructions to regulate a specific value (e.g., volume up/down, zoom in/out), to perform navigation between objects, or to perform a scroll between objects while a selected application mode is enabled in the mobile device. Related examples will be described later.

Now, described hereinafter is a method for controlling a particular operation of a mobile device through different touch zones. It will be understood by those skilled in the art that the present invention that the following presentation is merely descriptive and should is not to be considered limiting of the invention claimed.

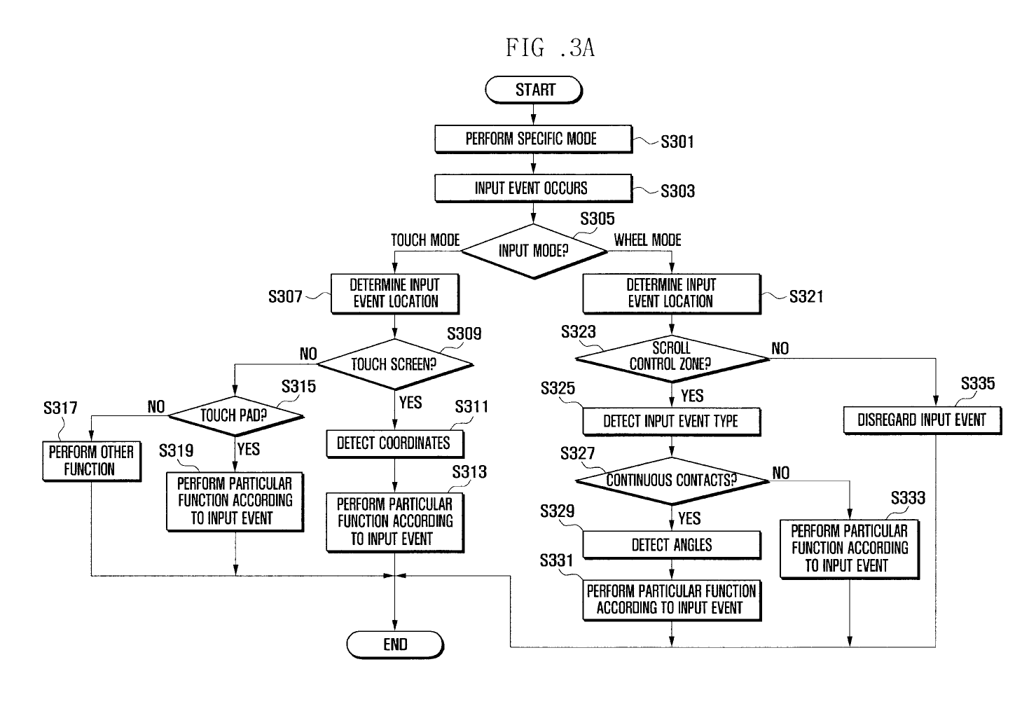

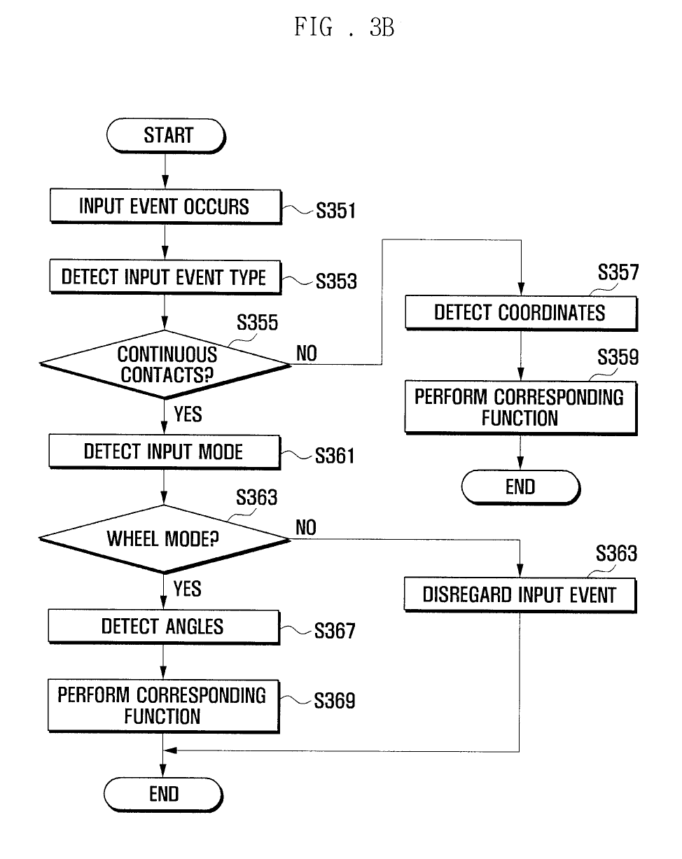

FIG. 3A is a flow diagram which illustrates a method for controlling a particular operation of a mobile device having different touch zones in accordance with an exemplary embodiment of the present invention.

Referring to FIGS. 1 to 3A, the mobile device performs a specific mode at the outset (step S301). In this step, a specific mode may be an execution mode of a particular function of a selected application, or an idle mode. When a user's input event occurs while a specific mode is performed (step S303), the mobile device determines whether an input mode is a wheel mode or a touch mode (step S305). In this step, an input mode refers to a manner or way of making an input through the scroll control zone 500.

As discussed in FIGS. 1 and 2, the wheel mode allows controlling a particular operation of the mobile device through an input event caused by continuous contacts, like a sweep event, in the scroll control zone 500. Also, the touch mode allows controlling a particular operation of the mobile device through an input event caused by a single contact, like a tap event, in the scroll control zone 500.

In embodiments of this invention, such input modes may be varied and based on applications or functions being executed in the mobile device. For instance, when a camera function is executed, the wheel mode may be assigned to regulations of zoom in/out values of the camera function. In the wheel mode, the mobile device may restrict an input function through the display zone 200. That is, the mobile device may activate only the half touch zone 300 to perform an input function.

In some embodiment of this invention, the mobile device may always detect an input event on the touch screen 100 in either the wheel mode or the touch mode. That is, both the wheel mode and the touch mode may allow a user's input event on the display zone 200 of the touch screen 100 as well as on the scroll control zone 500. However, FIG. 3A is a case where the scroll control zone 500 only is used.

In some embodiment of this invention, only one of the wheel mode and the touch mode may be used as an input mode according to executed applications. However, in other embodiments, both the wheel mode and the touch mode may be used together to operate as a continuous input device.

If it is determined in the step S305 that an input mode is a touch mode, the mobile device detects the location where an input event occurs (step S307). Thereby the mobile device determines whether an input event occurs in the touch screen 100, especially in the half touch zone 300 (step S309).

If an input event occurs in the touch screen 100, the mobile device detects the coordinates of the input event (step S311) and then performs a particular function corresponding to the input event (step S313).

However, if no input event occurs in the touch screen 100, the mobile device further determines whether an input event occurs in the touch pad 400 (step S315). If an input event occurs in the touch pad 400, the mobile device detects a tap point from the coordinates of the input event and then performs a particular function assigned to the tap point (step S319). However, if no input event occurs in the touch pad 400, the mobile device recognizes that an input event occurs anywhere (e.g., a function key, etc.) than in the touch screen 100 and the touch pad 400. Then the mobile device performs a suitable function corresponding to the input event (step S317).

On the other hand, if it is determined in the step S305 that an input mode is a wheel mode, the mobile device detects the location where an input event occurs (step S321). Thereby the mobile device determines whether an input event occurs in the scroll control zone 500, especially in the half touch zone 300 or in the touch zone of the touch pad 400 (step S323).

If no input event occurs in the scroll control zone 500, the mobile device recognizes that an input event occurs in the display zone 200 of the touch screen 100, and then disregards an input event (step S335). However, it would be recognized that the description of the invention is exemplary only and should not to be considered as a limitation of the present invention.

In one aspect, an input event in the display zone 200 in the wheel mode may be processed differently is accordance with device settings that may be provided by a user. That is, the mobile device may determine whether to accept an input event in the display zone 200 depending on the rules set by a user. If an input event in the display zone 20 is set to be received even in the wheel mode, the mobile device may perform a suitable function corresponding to the input event.

If an input event occurs in the scroll control zone 500, the mobile device detects a type of an input event (step S325). Thereby the mobile device determines whether an input event is caused by continuous contacts (step S327). That is, the mobile device determines whether an input event is caused by a single contact on the half touch zone 300 or the touch pad 400, or is caused by continuous contacts on at least one of the half touch zone 300 and the touch pad 400.

If an input event is caused by a single contact, the mobile device detects a tap point from the coordinates of the input event and then performs a function assigned to the tap point (step S333).

However, if an input event is caused by continuous contact, the mobile device detects angular information (step S329), and then performs a particular function corresponding to the input event (step S331). In this step, the continuous contact may be made in the half touch zone 300 only, in the touch pad 400 only, or from the half touch zone 300 to the touch pad 400 and vice versa.

Specifically, the mobile device detects input information from a continuous contact that is made in the half touch zone 300, and then sequentially performs a particular function depending on the detected input information. Similarly, the mobile device detects input information from the continuous contact made in the touch pad 400, and then sequentially performs a particular function depending on the detected input information. Also, the mobile device detects input information from a continuous contact that is made from the half touch zone 300 to the touch pad 400 and vice versa and then sequentially performs a particular function depending on the detected input information.

For instance, while the mobile device detects angular information from the half touch zone 300 and is performing a corresponding function, the mobile device may receive angular information from the touch pad 400 through a user's input event occurring without release. Then the mobile device regards the reception of angular information from the touch pad 400 as being caused by a single gestural input in the wheel mode and continues to perform the function without ceasing.

Similarly, while the mobile device detects angular information from the touch pad 400 and is performing a corresponding function, the mobile device may receive angular information from the half touch zone 300 through a user's input event. Then the mobile device regards the reception of angular information from the half touch zone 300 as being caused by a single gestural input and continues to perform a function without ceasing.

That is, if an input event is determined to be a user's single gestural input in the aforesaid step S327, the mobile device detects angular information depending on the progress of a user's gesture (step S329), and then performs a particular function corresponding to the input event (step S331).

Described heretofore in connection with FIG. 3A is a case where the mobile device operates based on an input mode depending on an executed application. However, according to another embodiment of this invention, the mobile device may operate based on an input mode depending on the occurrence location and the type of an input event.

Specifically, when a user's input event occurs, the mobile device may determine the occurrence location of an input event, namely, whether the input event occurs in the display zone 200 of the touch screen 100, in the half touch zone 300 of the touch screen 100, in the touch pad 400, or in the scroll control zone 500, and then may control the operation according to the occurrence location. Additionally, when a user's input event occurs, the mobile device may first determine the type of an input event, detect angular information delivered depending upon the input event when the input event is caused by continuous contacts, and control the operation according to the angular information detected. Related examples will be hereinafter described with reference to FIG. 3B. In the following description, the repetition of earlier described elements made with reference to FIGS. 1 to 3A will not be described in detail.

FIG. 3B is a flow diagram which illustrates a method for controlling a particular operation of a mobile device having different touch zones in accordance with another exemplary embodiment of the present invention.

Referring to FIGS. 1 to 3B, when a user's input event occurs, the mobile device detects the occurrence of the input event (step S351). Then the mobile device further detects the type of the input event (step S353). Thereby the mobile device determines whether the input event is caused by continuous contacts (step S355).

If the input event is not caused by continuous contacts, namely, if the input event is caused by a single contact, the mobile device detects the coordinates of the input event (step S357) and then performs a function corresponding to the input event (step S359).

If the input event is caused by continuous contact, the mobile device detects the current input mode depending on an executed application (step S361). Thereby the mobile device determines whether an input mode is set to a wheel mode in connection with the scroll control zone 500 (step S363).

If the input mode is not the wheel mode but a touch mode, the mobile device disregards the input event (step S365). However, if the input mode is the wheel mode, the mobile device detects angular information (step S367), and then performs the function corresponding to the input event (step S369).

Described hereinbefore is a method for controlling a particular operation of the mobile device depending on an input event on the touch screen and the touch pad. Now, described hereinafter is a method for detecting the input event according to the touch mode and the wheel mode.

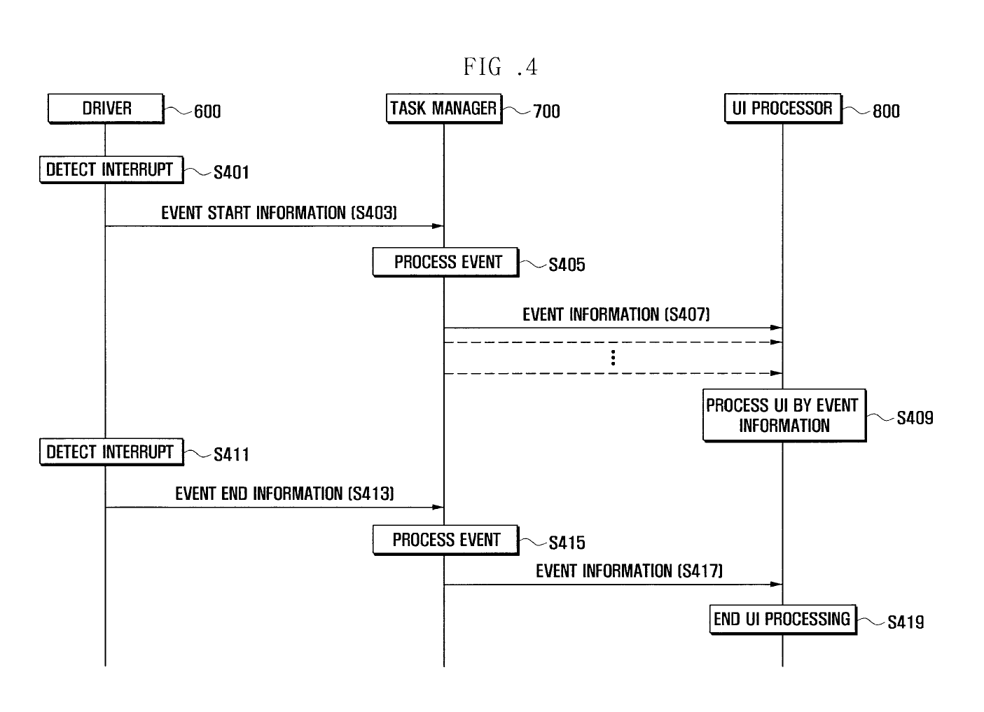

FIG. 4 is a flow diagram which illustrates a process of dealing with a user's input event in accordance with an exemplary embodiment of the present invention.

As shown in FIG. 4, the mobile device for processing a user's input event includes a driver 600, a task manager 700, and a UI processor 800.

Briefly, the driver 600 detects an interrupt produced in the touch screen 100, the touch pad 400 and the scroll control zone 500, and then sends a related event to the task manager 700. The task manager 700 processes a low level event sent by the driver 600 to obtain a high level event and sends it to the UI processor 800. Then the UI processor 800 processes a specific UI corresponding to the interrupt by using the high level event sent by the task manager 700 and offers it to the touch screen 100. Then the touch screen 100 displays data depending on the UI sent by the UI processor 800.

Referring to FIGS. 1 to 4, at the outset, the driver 600 detects a start interrupt of an input event (step S401), and then sends associated event start information to the task manager 700 (step S403). Since the input event may occur in one of the touch screen 100, the touch pad 400 and the scroll control zone 500, the event start information may be produced from one of the touch screen 100, the touch pad 400 and the scroll control zone 500. Therefore, if detecting the start interrupt in a specific input location, the driver 600 sends the event start information in connection with that specific input location to the task manager 700.

For instance, if an interrupt occurs from the touch screen 100, the driver 600 may send event start information “EV_TOUCH_PRESSED” corresponding to the interrupt by the touch screen 100 to the task manager 700. Alternatively, if an interrupt occurs from the scroll control zone 500, the driver 600 may send event start information “EV_TOUCH_WHEEL_PRESSED” corresponding to the interrupt by the scroll control zone 500 to the task manager 700.

When receiving the event start information from the driver 600, the task manager 700 processes the received event to obtain a high level event (step S405) and sends corresponding event information to the UI processor 800 (step S407).

For instance, if receiving the event start information in connection with the touch screen 100, the task manager 700 may process a corresponding event and then send event information “EV_TOUCH_PRESSED”, processed from the event start information, to the UI processor 800. Alternatively, if receiving the event start information in connection with the scroll control zone 500, the task manager 700 may process a corresponding event and then send event information “EV_TOUCH_WHEEL_PRESSED”, processed from the event start information, to the UI processor 800.

The task manager 700 continues to process events until receiving an event end information from the driver 600, and continues to send processed event information to the UI processor 800.

For instance, if an interrupt occurs from the touch screen 100 in the touch mode and then moves by a sweep event or a flick event, the task manager 700 may send event information “EV_TOUCH_MOVE” to the UI processor 800. Alternatively, if an interrupt occurs from the scroll control zone 500 in the wheel mode and then moves by a sweep event, the task manager 700 may send event information “EV_TOUCH_WHEEL_MOVE” to the UI processor 800.

When receiving the event information from the task manager 700, the UI processor 800 processes a corresponding UI altered or requested by the interrupt while using the received event information (step S409). Then the processed UI is offered to the touch screen 110. If the event information is sequentially received from the task manager 700 according to a move of the interrupt, the UI processor 800 continues to process a corresponding UI based on a sequential reception of the event information.

In the meantime, the driver 600 detects an end interrupt of an input event (step S411), and then sends event end information to the task manager 700 (step S413). Here, the event end information indicates a release of a user's input event occurring in one of the touch screen 100, the touch pad 400 and the scroll control zone 500. Therefore, if detecting an interrupt indicating a release of the input event, the driver 600 sends the event end information to the task manager 700.

For instance, if an interrupt is released from the touch screen 100, the driver 600 may send event end information “EV_TOUCH_RELEASED” to the task manager 700. Alternatively, if an interrupt is released from the scroll control zone 500, the driver 600 may send event end information “EV_TOUCH_WHEEL_RELEASED” to the task manager 700.

When receiving the event end information from the driver 600, the task manager 700 processes a received event to obtain a high level event (step S415) and sends corresponding event information to the UI processor 800 (step S417).

For instance, if receiving the event end information in connection with the touch screen 100, the task manager 700 may process a corresponding event and then send event information “EV_TOUCH_RELEASED”, processed from the event end information, to the UI processor 800. Alternatively, if receiving the event end information in connection with the scroll control zone 500, the task manager 700 may process a corresponding event and then send event information “EV_TOUCH_WHEEL_RELEASED”, processed from the event end information, to the UI processor 800.

When receiving the event information from the task manager 700, the UI processor 800 ends a UI processing corresponding to the received event information (step S419).

On the other hand, although not illustrated in FIG. 4, the same process may be applied to another input event in connection with the result request zone 550 in the scroll control zone 300. Normally, in the result request zone 550, an input event happens by a single contact such as a touch or a tap. Therefore, some step such as an event processing by the task manager 700 may be favorably omitted.

For instance, if an interrupt occurs from the result request zone 550, the driver 600 may send corresponding event start information “EV_KEY_PRESSED” directly to the UI processor 800. Similarly, if an interrupt is released from the result request zone 550, the driver 600 may send corresponding event end information “EV_KEY_RELEASED” directly to the UI processor 800.

Now, a method for detecting a user's input event will be described in detail.

According to embodiments of this invention, an input state register of the driver 500 offers an input state in connection with each of the touch screen 100, the scroll control zone 500 and the result request zone 550. The input state register may be composed of a coordinate register and a scroll position register.

Specifically, in a case of using the touch screen 100 or the half touch zone 300 of the scroll control zone 500, the coordinate register may offer values of x and y coordinates where an input event occurs. Particularly, this case may be applied to the touch mode which allows a tap event by a single contact.

On the other hand, in another case of using the scroll control zone 500, namely, using the half touch zone 300 and the touch pad 400, the scroll position register may offer angular values within a predefined range (e.g., from 0 to 255) allotted in a clockwise direction to the scroll control zone 500. Particularly, this case may be applied to the wheel mode which allows a sweep event by continuous contact. Here, angular values from 0 to 255 are exemplary only and not to be considered as a limitation of the present invention. The angular values may be defined as a variety of ranges in consideration of the size of a surface used as the scroll control zone 500.

Meanwhile, as discussed above, the wheel mode normally allows detecting angular values in connection with a continuous gestural input.

The present invention is, however, not limited to the above. Alternatively or additionally, the wheel mode may allow detecting coordinate values in connection with a single input.

Also, in the wheel mode using the scroll control zone 500, a speed scroll gesture function may be offered depending on the speed of the progress of a user's gestural input until such an input is released.

As discussed hereinafter, the touch mode allows detecting an input event occurring in one of the touch screen 100 and the touch pad 400, and also allows processing a corresponding UI by using coordinate values of the detected input event. On the other hand, the wheel mode allows detecting an input event occurring in the scroll control zone 500, and also allows processing a corresponding UI by using coordinates values or angular values of the detected input event.

Described hereinbefore is a method for controlling a particular operation of the mobile device according to an input event by input modes occurring in the touch screen and the touch pad. Now, described hereinafter are examples of such a particular operation, especially an operation in a case of using the scroll control zone 500. It will be understood by those skilled in the art that the present invention is not limited to the following.

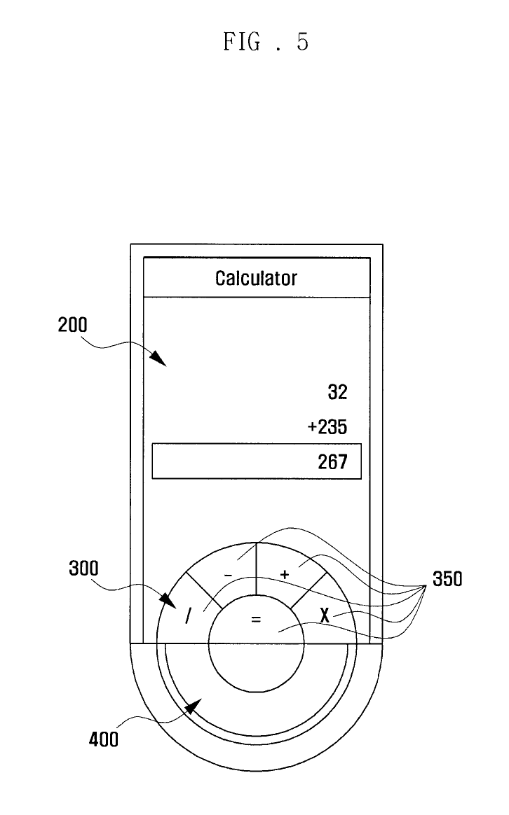

FIG. 5 is a screen view which illustrates an example of executing a predefined function assigned to tap points on different touch zones in accordance with an exemplary embodiment of the present invention. Particularly, FIG. 5 shows a case where the half touch zone 300 is used in the touch mode.

Referring to FIGS. 1 to 5, in order to control a particular operation of the mobile device, tap points may be allotted to the half touch zone 300 (i.e., the first touch zone) of the touch screen 100 and the touch zone (i.e., the second touch zone) of the touch pad 400. Each individual tap point corresponds to a predetermined function of a certain executable application. FIG. 5 shows several tap points allotted to only the half touch zone 300 of the touch screen 100. Alternatively, in another embodiment, such tap points may be allotted to the touch zone of the touch pad 400 as well as the half touch zone 300 of the touch screen 100. However, even in this case, predefined virtual items, namely, GUI patterns or forms for functions assigned to the tap points may be displayed on only the half touch zone 300 of the touch screen 100.

FIG. 5 shows a case where a calculator, one of the executable applications in the mobile device, is executed. As shown in FIG. 5, the half touch zone 300 of the touch screen 100 displays virtual items 350, such as calculation symbols (+, −, ×, /, =). When a tap event happens at one of the tap points displayed on the half touch zone 300, a specific calculation symbol assigned to the selected tap point is inputted into the mobile device.

Furthermore, the virtual items 350 displayed on the half touch zone 300 may vary according as which application is executed. That is, each individual tap point may be assigned to different functions, depending on the application being executed. Such virtual items may be provided as default values when the mobile device is manufactured, or changed according to a user's setting. Also, the touch zone of the touch pad 400 may render a control function, such as an option, a menu, a confirmation, etc., to the mobile device, depending on a user's tap event thereon.

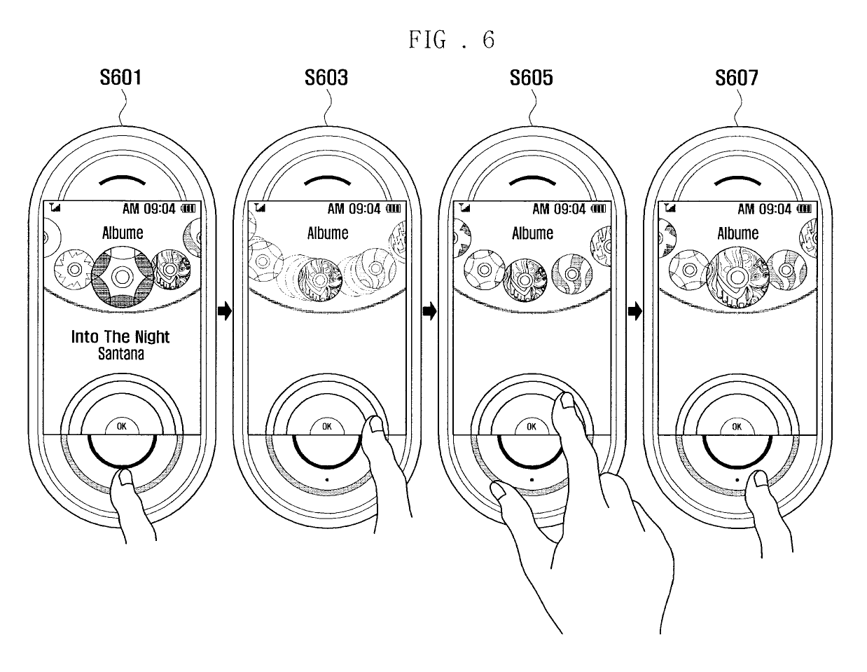

FIG. 6 is a screen view which illustrates one example of executing a predefined function through a sweep event on different touch zones in accordance with an exemplary embodiment of the present invention. Particularly, FIG. 6 shows a case where the half touch zone 300 is used in the wheel mode.

Referring to FIG. 6, the mobile device may execute and display a specific application in response to a user's request as indicated by a reference number S601. Particularly, FIG. 6 shows an example in which a disk UI is offered according to the execution of an application in connection with a multimedia item play. In the disk UI, the mobile device displays on the display zone 200 disk-shaped images corresponding to multimedia items in a user's selected category, and also displays a virtual item with a predefined GUI on the half touch zone 300 of the touch screen 100.

Then the mobile device performs a control for the displayed images on the display zone 200 in response to a user's control input as indicated by reference numbers S603, S605 and S607. That is, depending on a user's gestural input of a continuous contact on the scroll control zone 500, the mobile device offers visual effects caused by navigation between the disk-like images. At this time, a user's gestural input may occur through continuous contact in a clockwise or counterclockwise direction on at least one of the half touch zone 300 and the touch pad 400. Shown in FIG. 6 is a case where the mobile device performs navigation between the disk-like images, depending on a gestural input direction on the scroll control zone 500.

If a user selects a specific multimedia item after navigation through the scroll control zone 500, the mobile device displays an enlarged disk-like image corresponding to the selected multimedia item on the display zone 200 as indicated by a reference number S607. Namely, when a user's input by continuous contact is released from the scroll control zone 500, the mobile device recognizes that a search through navigation is ended. Then the mobile device activates a specific image selected at the time of a release and offers it on the display zone 200.

Additionally, a user may give a command to play the selected multimedia item through the activated image on the display zone 200 as indicated by a reference number S607. Here, a user's play command may be produced from various input events such as a tap event on the activated image in the display zone 200, an input event on the result request zone 550 in the scroll control zone 500, an input event on a virtual item for confirmation and selection in the half touch zone 300 or the touch pad 400, or an input event on a tap point indicating a specific direction in the touch pad 400 as indicated by a reference number S607.

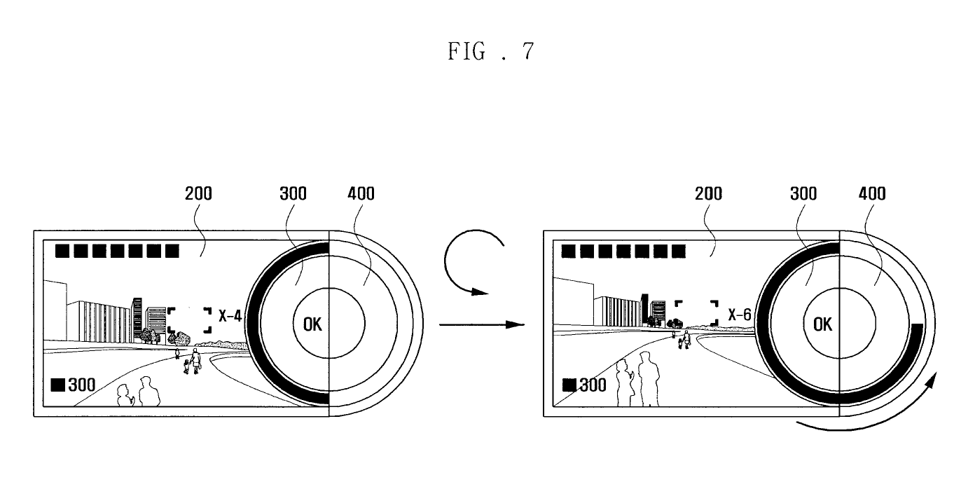

FIG. 7 is a screen view which illustrates another example of executing a predefined function through a sweep event on different touch zones in accordance with an exemplary embodiment of the present invention. Particularly, FIG. 7 shows a case where the half touch zone 300 and the touch pad 400 are used together in the wheel mode.

Referring to FIG. 7, while a certain application mode is enabled in the mobile device, at least one value may be regulated through the scroll control zone 500. Particularly, in FIG. 7, a camera application is executed, and a preview image is zoomed in or out depending on interactions through the half touch zone 300 and the touch pad 400. In this case, the mobile device may receive an input through the scroll control zone 500 with the wheel mode enabled, and may control an operation for regulating given values by angular information corresponding to a user's gesture (i.e., a sweep event).

FIG. 7 shows, in particular, a case of performing a zooming in operation through a gestural input on the half touch zone 300 and the touch pad 400. Furthermore, FIG. 7 shows a case where a gestural input starts from the half touch zone 300 of the touch screen 100. However, such a gestural input for a zooming in may alternatively start from the touch zone of the touch pad 400.

In addition, FIG. 7 shows a case where a zoom-in function may depend on a clockwise sweep gesture. The same way may be applied to a zoom-out function. That is, a zoom-in function is performed depending on a continuous movement (e.g., touch and moving) in a clockwise direction on the scroll control zone 500, whereas a zoom-out function is performed depending on a continuous movement in a counterclockwise direction on the scroll control zone 500.

Although not illustrated, such zoom-in and zoom-out functions may be performed depending on whether the sweep events occur in a clockwise or a counterclockwise direction on only one of the half touch zone 300 and the touch pad 400 in the scroll control zone 500. Furthermore, FIG. 7 shows a case where a sweep event for a zooming in or zooming out operation (function) starts from one end of the touch zone and then travels toward the other end. However, such a sweep event may alternatively start from any arbitrary point within the touch zone instead of the end. That is, the start point of a zooming in or out may depend on a user's intentions, and the mobile device may perform a zooming in or out depending on such a start point.

In FIG. 7, a clockwise direction is assigned to a zooming in operation, and a counterclockwise direction is assigned to a zooming out operation. However, such assignment may be varied according to a user's setting or predefined information in manufacture.

Additionally, the above discussed regulating operation in the scroll control zone 500 may be similarly applied to volume up/down operation of a music file or any other regulation of specific values while a selected application mode is enabled.

Meanwhile, in FIG. 7, lines and arrows displayed in the scroll control zone 500 to indicate the extent and direction of a gesture are merely imaginary expressions for a full understanding and may be actually not displayed. Besides, a screen image of a target object by a camera function may be offered in only the display zone 200 of the touch screen 100 or in the entire touch screen 100 as shown in FIG. 7.

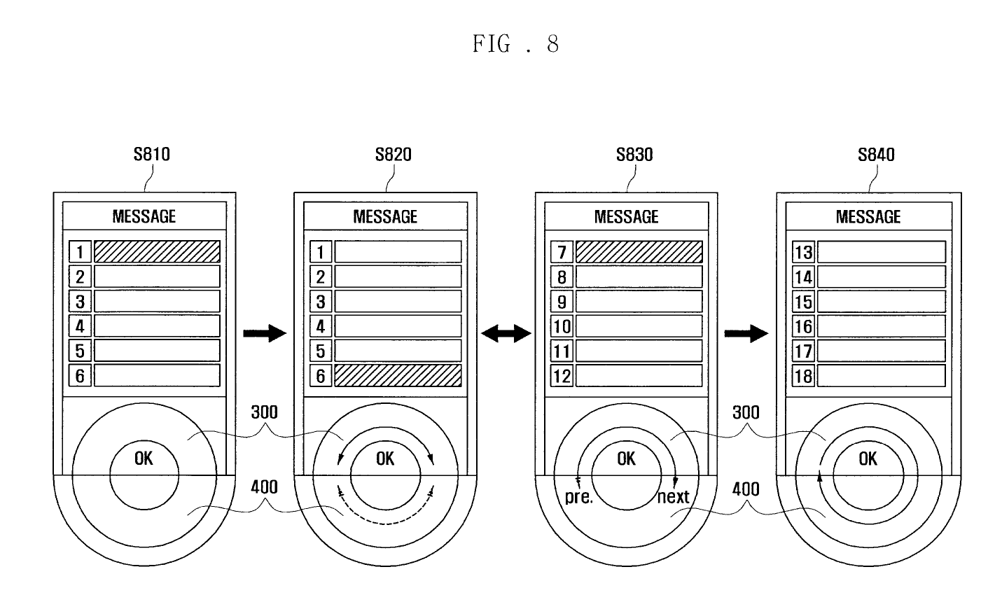

FIG. 8 is a screen view which illustrates still another example of executing a predefined function through a sweep event on different touch zones in accordance with an exemplary embodiment of the present invention. Particularly, FIG. 8 shows a case where the half touch zone 300 and the touch pad 400 are used together in the wheel mode.

Referring to FIG. 8, a list of received messages is represented. Here, a user can perform navigation between articles (i.e., individual received messages) in the message list through a sweep event on the half touch zone 300 of the touch screen 100 and the touch zone of the touch pad 400. In FIG. 8, characters ‘next’ and ‘pre’ and circular arrows represented in the scroll control zone 500 are merely imaginary expressions for a full understanding and may not be actually displayed.

As indicated by reference numbers S810 and S820, a user can perform navigation between articles arranged in the list through a sweep event which occurs on the half touch zone 300 of the touch screen 100 or the touch zone of the touch pad 400. In two cases S810 and S820, a currently displayed category contains six articles from ‘1 ’ to ‘6 ’ for example, and a clockwise or counterclockwise sweep event in only one touch zone may result in navigation from the first article ‘1 ’ to the sixth article ‘6 ’, wherein the selected item is illustrated by being displayed with cross-hatching.

Alternatively, a sweep event may occur on the entire scroll control zone 500 to perform navigation within a current category. However, in this example shown in FIG. 8, a movement from one touch zone to the other is assigned to a change of a category, thus allowing an extended navigation to previous or next categories depending on the direction of a sweep event.

That is, as indicated by a reference number S830, a sweep event may occur from one touch zone (e.g., the half touch zone 300 of the touch screen 100) to the other touch zone (e.g., the touch zone of the touch pad 400), maintaining continuous contacts without released. This sweep event is accepted as instructions to perform an extended navigation.

As indicated by a reference number S820, a user can perform navigation between articles in a current category through a clockwise or counterclockwise sweep event within only the half touch zone 300 of the touch screen 100. By the way, as indicated by a reference number S830, a user can take a clockwise sweep gesture from the half touch zone 300 of the touch screen 100 to the touch zone of the touch pad 400 through continuous contacts. This results in a change of a category displayed on the display zone 200. That is, by a sweep event on different touch zones, currently displayed articles (‘1’ to ‘6 ’) in a certain category are changed into other articles (‘7’ to ‘12 ’) in the next category. Then, if a user takes a counterclockwise sweep gesture from the half touch zone 300 to the touch pad 400, currently displayed articles (‘7’ to ‘12 ’) are changed into other articles (1′ to ‘6 ’) in the previous category.

Such a change of a category may be alternatively made through a sweep event from the touch zone of the touch pad 400 to the half touch zone 300 of the touch screen 100.

On the other hand, if a user continues the aforesaid sweep gesture, a change of a category may also be made continually as indicated by a reference number S840. For example, if a sweep event starts at the half touch zone 300, passes through the touch pad 400, and finally ends at the half touch zone 300, a change of a category may be made twice.

As discussed heretofore, continuous contact on the scroll control zone 500 are accepted as a single gestural input. That is, although a touch zone where a sweep event happens is changed, the mobile device regards this sweep event as a single gestural input. Therefore, the mobile device continues to control a particular operation regardless of a change of a touch zone.

The above is a case where a change of a category is made through an extended sweep gesture during navigation in a selected category. Alternatively, a change of a category may be performed through a tap event on a predefined tap point or through a shorter sweep event at the border between different touch zones.

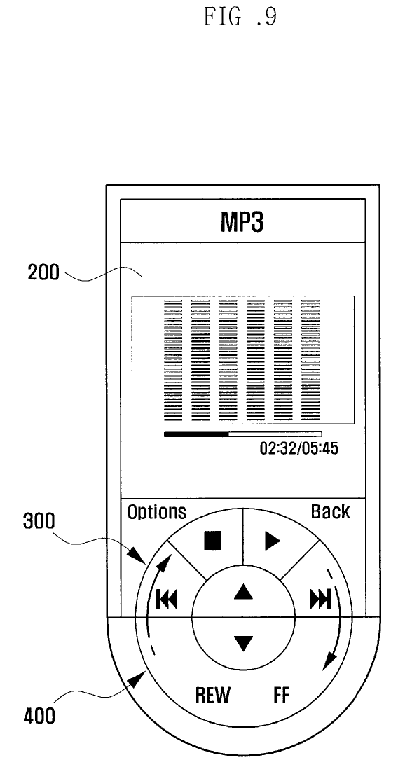

FIG. 9 is a screen view which illustrates an example of executing a predefined function depending on a tap event and a sweep event on different touch zones in accordance with an exemplary embodiment of the present invention. Particularly, shown in FIG. 9 is a case where a specific operation of the mobile device controlled through a tap event or a sweep event on the scroll control zone 500 in connection with an executed application.

Referring to FIG. 9, some tap points are allotted to the half touch zone 300 of the touch screen 100 and the touch zone of the touch pad 400, while corresponding to predetermined functions of a certain executable application. A particular operation of the mobile device may be controlled through a tap event occurring on such tap points. In addition, a sweep event on the different touch zones such as the half touch zone 300 of the touch screen 100 and the touch zone of the touch pad 400 may also be used to control a particular operation.

FIG. 9 exemplarily shows the execution of a music play application. As shown, the half touch zone 300 of the touch screen 100 may represent virtual items ( [symbol] , ▪, [symbol] , [symbol] , ▴, ▾) for a function control of a music play at their tap points. A user can take a tap gesture at a specific tap point so as to perform a specific function of a music play. Here, virtual items represented in the touch zone of the touch pad 400 are merely imaginary expressions for a full understanding, and virtual items only in the half touch zone 300 of the touch screen 100 actually appear.

In addition to taking a tap gesture, a user can take a sweep gesture on the different touch zones in the scroll control zone 500. For example, a sweep event in a clockwise or counterclockwise direction is assigned to a volume up or down, a fast forward (FF) or a rewind (REW), a search of previous or next music files, or any other functions defined by a user's setting.

Furthermore, the display zone 200 of the touch screen 100 may represent a given data related to the execution of an application. As shown, a graphic equalizer, a progress bar, a music title, words of song, etc. may be represented in connection with a music play.

Described heretofore is a method for controlling a particular operation of the mobile device through interactions through different touch zones in the touch screen and the touch pad. Next, a mobile device for executing the above method will be described hereinafter. The following mobile device is a mobile communication terminal such as a mobile phone, but the present invention is not limited thereto.

The mobile device according to this invention may include many kinds of mobile communication terminals based on various communication protocols in a variety of communication systems, a personal digital assistant (PDA), a smart phone, a portable multimedia player (PMP), a music player, a digital multimedia broadcasting (DMB) player, a car navigation system, a game console, and any other kinds of portable or handheld devices.

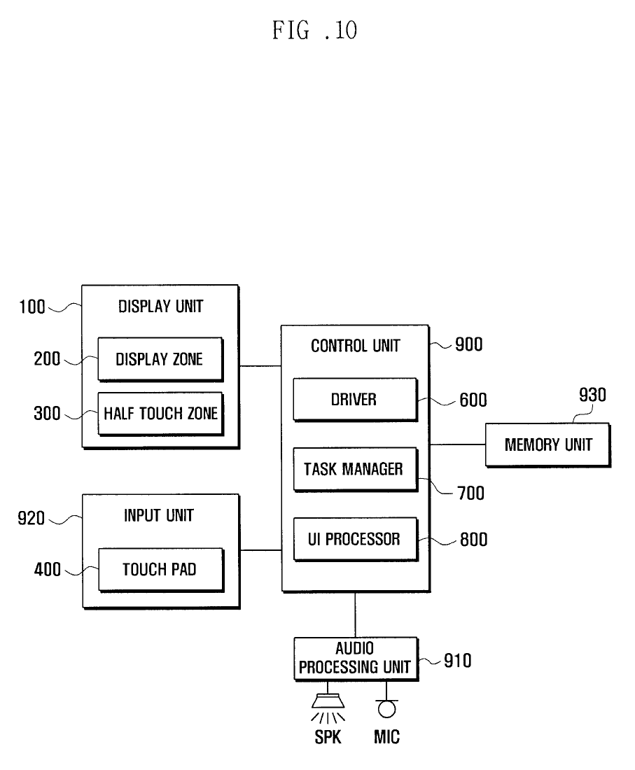

FIG. 10 is a block diagram which illustrates a configuration of a mobile device in accordance with an exemplary embodiment of the present invention.

Described herein is a case where the display unit 100 of the mobile device is formed of a touch screen. However, the display unit 100 of this invention is not limited to the use of a touch screen. The display unit 100 may be formed of a normal LCD, while a part of the display unit 100 is formed of a touch zone which is disposed in the vicinity of the touch pad and thus forms together an organized combination structure.

Referring to FIG. 10, the mobile device includes an audio processing unit 910, an input unit 920, a display unit 100, a memory unit 930, and a control unit 900. As described above, the display unit 100 has the display zone 200 and the half touch zone 300. In addition, the input unit 920 has the aforesaid touch pad 400, function keys, a keypad, etc. Also, the control unit 900 includes a driver 600, a task manager 700, and a UI processor 800.

The audio processing unit 910 may output a variety of audio components (e.g., audio signals while a music file is played) generated in the mobile device according to a user's selection. The audio processing unit 910 receives audio signals from the microphone (MIC) and then outputs audio data to the control unit 900. In addition, the audio processing unit 910 receives audio signals from the control unit 900 and then outputs audible sounds through the speaker (SPK).

The input unit 920 receives information from a user, creates related input signals, and sends them to the control unit 900. The input unit 920 may include a keypad and any other well known input means. In particular, the input unit 920 of this invention has the aforesaid touch pad 400 that may receive a user's touch-related gestural input event.

As discussed above, the touch pad 400 is a kind of physical medium which allows processing a user's input through touch-based interaction between human and the device. In particular, the touch pad 400 has the touch zone for receiving a user's gestural input event. The touch pad 400 detects such an input event and then sends it to the control unit 900. Particularly, when some input event such as a tap event or a sweep event is detected, the touch pad 400 sends coordinate information or angular information produced in connection with the input event to the control unit 900. Then the control unit 900 controls a particular operation corresponding to the received input event. In some embodiment of this invention, the input unit 920 may be formed of the touch pad 400 only.

The display unit 100 may be composed of the display zone 200 and the half touch zone 300. If the display unit is formed of a touch screen, the display unit may have an input function in addition to a display function.

The display unit 100 offers graphical data on a screen in connection with the state and operation of the mobile device. Also, the display unit 100 visually represents signals and color data outputted from the control unit 900. In addition, the display unit 100 receives a user's touch-based input, creates a related input signal, and sends it to the control unit 900. Particularly, the display unit 100 receives a tap event, a flick event, a sweep event, a drag and drop event, etc. for a function control in connection with an executed application. Then the display unit 100 creates signals related to such input events and sends them to the control unit 900.

In some embodiments of this invention, the display zone 200 not only outputs information on a screen, but also receives a user's input event for controlling a specific operation of the mobile device while information is outputted on a screen. That is, the display zone 200 allows receiving various input events in addition to an inherent display function. In this case, the display zone 200 detects an input event by a user, creates a signal related to the detected input event, and sends the created signal to the control unit 900.

The half touch zone 300 receives a user's input event. That is, the half touch zone 300 receives a tap event and a sweep event for controlling a particular operation of the mobile device. Particularly, the half touch zone 300 forms an organized combination structure together with the adjacent touch zone of the touch pad 400. Then the half touch zone 300 may receive an input event through continuous contacts in association with the touch zone of the touch pad 400. Additionally, the half touch zone 300 represents virtual items in GUI patterns or forms which may vary to be adapted to a specific application being executed. When receiving a user's input event such as a tap event or a sweep event, the half touch zone 300 detects coordinate information or angular information of the received input event and sends it to the control unit 900. That is, the half touch zone 300 detects a user's touch, creates a signal related to the detected touch, and sends it to the control unit 900.

In embodiments of this invention, the display unit 100 is disposed in the vicinity of the touch pad 400 of the input unit 920. Also, the half touch zone 300 of the display unit 100 is disposed near the touch zone of the touch pad 400.

The memory unit 930 may be composed of ROM (read only memory) and RAM (random access memory). The memory unit 930 may store a great variety of data created and used in the mobile device. Such data includes internal data created during the execution of applications in the mobile device, and external data received from external entities such as a base station, other mobile device, and a personal computer. In particular, data stored in the memory unit 930 may include user interfaces offered by the mobile device, setting information related to the use of the mobile device, virtual items defined in connection with executable applications, and other information necessary for function control related to a user's gesture.

Additionally, the memory unit 930 may store applications required for controlling a general operation of the mobile device, and applications required for controlling a particular operation of the mobile device as discussed above. These applications may be stored in an application storage region (not shown). Also, the memory unit 930 may include at least one buffer which temporarily stores data produced in the execution of the above applications.

The control unit 900 performs an overall control function related to the mobile device and controls the flow of signals between elements in the mobile device. That is, the control unit 900 controls signal flows between the aforesaid elements, namely, the audio processing unit 910, the input unit 920, the input unit 100, and the memory unit 930. The control unit 900 processes touch-based signals caused by input events received from the display unit 100 and the touch pad 400.

Particularly, the control unit 900 accepts a continuous input, which occurs on both the half touch zone 300 of the display unit 100 and the touch zone of the touch pad 400, as a single gestural input. Also, the control unit 900 controls a particular operation (e.g., UI processing) of the mobile device, depending on signals (e.g., angular information) sequentially delivered by interactions through the half touch zone 300 and the touch pad 400. For instance, if angular information is sent from the touch pad 400 while a function is controlled depending on angular information sent from the half touch zone 300, the control unit 900 continues to control that function by using angular information sent from the touch pad 400. That is, although a touch zone where an input event occurs is changed in the scroll control zone 500, the control unit 900 may regard such an input event as a single gestural input for regulating a specific value (e.g., volume up/down, zoom in/out, etc.) or for performing navigation between items.

In some embodiment of this invention, if any input event such as a sweep event sequentially occurs through neighboring touch zones in the scroll control zone 500, the control unit 900 may recognize such an input event as a single gestural input and then control a specific function corresponding to an executed application. For instance, when an input event starting from the touch pad 400 is detected from the half touch zone 300 next to the touch pad 400, the control unit 900 regards it as a single gestural input. Therefore, although a touch zone from which an input event is detected is changed from one to the other of different touch zones, the mobile device may continue to control a particular operation regardless of a change of a touch zone.

That is, when continuous contacts are inputted sequentially from different touch zones such as the display unit 100 and the touch pad 400, the control unit 900 accepts this input as a single gestural input and continues to control a particular operation depending successively on a single gestural input regardless of a change of touch zones.

Meanwhile, the control unit 900 controls specific functions through interactions of a tap event and a sweep event occurring in the scroll control zone 500 with different touch zones. Besides, the control unit 900 controls the representation of virtual items in connection with an executed application on the half touch zone 300 of the display unit 100.

This control unit 900 includes the driver 600 configured to detect interrupt produced in the display unit 100, the touch pad 400 and the scroll control zone 500, and to output a related event. The control unit 900 further includes the task manager 700 configured to process a low level event sent by the driver 600 to obtain a high level event, and to output it. Also, the control unit 900 further includes the UI processor 800 configured to process a specific UI corresponding to the interrupt by using the high level event sent by the task manager 700, and to offer it to the display unit 100.

Generally the control unit 900 may control particular operations in connection with the present invention as discussed above with reference to FIGS. 1 to 10. The control function of the control unit 900 may be embodied in the form of software.

Although configuration of the mobile device is schematically shown in FIG. 10, this is exemplary only and not to be considered as a limitation of the present invention.

If the mobile device of this invention supports a mobile communication service, the control unit 900 may have a baseband module commonly used for a mobile communication service of the mobile device. Additionally, the mobile device may have a radio frequency (RF) unit which is configured to establish a communication channel with an available mobile communication network and to perform communication such as a voice call, a video telephony call, and a data communication. Also, the audio processing unit 910 may further have an audio signal processing function in connection with a mobile communication service.

Although not illustrated, any other elements may be essentially or selectively included in the mobile device of the present invention. For example, the mobile device may further include a camera module, a digital broadcast receiving module, a short distance communication module, an Internet access module, and so forth. Additionally, as will be understood by those skilled in the art, some of the above-discussed elements in the mobile device may be omitted or replaced with another.

On the other hand, the present invention is not limited to the mobile device discussed heretofore. Many types of electronic devices which have a suitable input unit for receiving a user's touch-based gestural input may also be favorably applied to this invention. Such input units used for this invention may include, but not limited to, a motion sensor which recognizes a user's motion and thereby creates a gestural input signal, a touch pad or a touch screen which creates a gestural input signal caused by contacts and movement of a specific object such as a finger or a stylus pen, and a voice recognition sensor.

Additionally, the electronic device may include a great variety of mobile devices (i.e., a mobile phone, a PDA, a smart phone, a PMP, a music player, a DMB player, a car navigation system, a game console, and any other kinds of portable or handheld devices), and a variety of display devices or players (i.e., TV, LFD, DS, media pole, etc.). The display unit used for the electronic device may be formed of various display devices such as a liquid crystal display (LCD), a plasma display panel (PDP), an organic light emitting diodes (OLED), and any other equivalents.

In some case where this invention is embodied in the display device, the input unit may be formed of the touch pad and the touch screen, which may be integrated with the display device or may be provided in the form of a separate unit. Here, in addition to the touch pad and the touch screen, the separate unit may include a gyro sensor, an accelerator sensor, an IR LED, an image sensor, each of which is configured to recognize a motion or a pointing action. For example, the separate unit may be formed of a remote controller, which has a keypad to receive a user's button press input. Such separate units may offer input signals to the electronic device through a wired or wireless communication, so that the electronic device may recognize a user's input gesture.

According to this invention, by integrally and interactively using the touch screen and the touch pad, the usability of electronic devices may be enhanced. That is, the electronic device of this invention configures an interactive, adjoining, organized combination structure of different touch zones, using the touch screen and the touch pad, which may be used as separate individual input units or an integrated signal input unit according to executed application and/or operation mode. Therefore, this may increase efficiencies of user's input and control actions.

Furthermore, according to this invention, the first touch zone of the touch screen and the second touch zone in the touch pad may be disposed adjacently and symmetrically. When continuous contacts occur on the first and second touch zones, these contacts are accepted as a single gestural input for controlling a particular operation of an electronic device.

Additionally, touch zones of this invention may be graphically realized in the form of a wheel-like rotatable input device, so an input interface may become more intuitive and promote visibility. Furthermore, since the touch screen may represent virtual images with GUI patterns adapted to a currently executed application, many function can be expressed more intuitively.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. An input system of an electronic device having different touch zones, comprising:
a touch screen including a first touch zone disposed adjacently and symmetrically to a second touch zone, the first touch zone being configured to receive a continuous contact in association with the second touch zone, and the first touch zone creating first input information connected to second input information created by the second touch zone when the continuous contact starting from the second touch zone is inputted; and
a touch pad including the second touch zone configured to receive the continuous contact in association with the first touch zone, the second touch zone creating the second input information connected to the first input information created by the first touch zone when the continuous contact starting from the first touch zone is inputted.

2. The input system of claim 1, wherein each of the first input information and the second input information includes angle information corresponding to the continuous contact through the first touch zone and the second touch zone.

3. The input system of claim 2, wherein the first touch zone and the second touch zone have an organized combination and a symmetric structure and are used together as a scroll control zone that receives an input event caused by the continuous contact.

4. The input system of claim 3, wherein the angle information is assigned in advance to the scroll control zone by using a predefined range of values corresponding to a surface size of the scroll control zone.

5. The input system of claim 2, wherein the touch screen has at least one of: an entire touch zone and a partial touch zone adjacent to the touch pad, the partial touch zone including a half touch zone.

6. The input system of claim 5, wherein the first touch zone is formed of the half touch zone which offers at least one of: coordinate information and angular information, corresponding to a user's input event.

7. The input system of claim 5, wherein the half touch zone is configured to display a virtual item corresponding to an executed application.

8. The input system of claim 4, wherein the scroll control zone is configured to offer coordinate information in connection with a single contact or offer angular information in connection with the continuous contact according to an input mode depending on an executed application of the electronic device.

9. An electronic device comprising:
a touch screen including a first touch zone;
a touch pad disposed near the touch screen and including a second touch zone disposed adjacently to the first touch zone; and
a control unit configured to determine an input mode depending on an executed application, and to control a specific function in response to input information received from the first and second touch zones in the determined input mode.

10. The electronic device of claim 9, wherein the input mode includes a touch mode which allows a single input from the first and second touch zones, and a wheel mode which allows continuous input from the first and second touch zones.

11. The electronic device of claim 10, wherein the control unit is further configured to detect coordinate information offered from the first and second touch zones in the touch mode, and to control the specific function by using the coordinate information.

12. The electronic device of claim 10, wherein the control unit is further configured to detect angular information offered from the first and second touch zones in the wheel mode, and to control the specific function by using the angular information.

13. The electronic device of claim 12, wherein if the angular information is sequentially offered from the first and second touch zones, the control unit is further configured to accept the angular information as a single gestural input.

14. The electronic device of claim 12, wherein the first and second touch zones have an organized combination and a symmetric structure and are used together as a scroll control zone that receives an input event caused by the continuous contact.

15. The electronic device of claim 14, wherein the angle information is assigned in advance to the scroll control zone by using a predefined range of values corresponding to a surface size of the scroll control zone.

16. The electronic device of claim 9, wherein the touch screen has at least one of an entire touch zone or a partial touch zone, adjacent to the touch pad, the partial touch zone including a half touch zone.

17. The electronic device of claim 16, wherein the half touch zone is configured to display a virtual item corresponding to an executed application.

18. The electronic device of claim 15, wherein the scroll control zone is configured to offer at least one of: coordinate information in connection with a single contact and angular information in connection with the continuous contact, according to an input mode depending on an executed application of the electronic device.

19. A method for controlling an operation of an electronic device having different touch zones, the method comprising:
determining a type of an input event received from the different touch zones;
if the input event is caused by a continuous contact, determining an input mode using the different touch zones;
if the input mode is a wheel mode, detecting angular information corresponding to the input event; and
controlling a specific function of the operation in response to the input event by using the angular information.

20. The method of claim 19, wherein the different touch zones forms a scroll control zone which includes a first touch zone of a touch screen and a second touch zone of a touch pad, the first and second touch zones having an organized combination and a symmetric structure.

21. The method of claim 20, further comprising:
if the input mode is a touch mode, disregarding the input event.

22. The method of claim 20, further comprising:
if the input event is caused by a single contact, detecting coordinate information corresponding to the input event; and
controlling a specific function of the operation in response to the input event by using the coordinate information.

23. The method of claim 20, wherein if the angular information is offered from one of the first and second touch zones, the detecting of the angular information includes detecting the angular information in one of the first and second touch zones.

24. The method of claim 20, wherein if the angular information is sequentially offered from both the first and second touch zones, the detecting of the angular information includes detecting the angular information in both the first and second touch zones while accepting the angular information as a single gestural input.
